(19) United States
(12) Patent Application Publication
(10) Pub. No.: US 2015/0059791 A1
(43) Pub. Date: Mar. 5, 2015

(54) FLOSS TYPE CLEANING DEVICE

(71) Applicant: Russell M. Sheppel, San Luis Obispo, CA (US)

(72) Inventor: Russell M. Sheppel, San Luis Obispo, CA (US)

(21) Appl. No.: 14/019,200

(22) Filed: Sep. 5, 2013

(51) Int. Cl. A61C 15/04

(52) U.S. Cl. CPC A61C 15/046
USPC 132/200; 132/323

(57) ABSTRACT

A device and method for its use for cleaning teeth. An uninterrupted floss-type loop, is supported by an implement. The implement includes a handle portion sized to be gripped by a user and a pair of extensions emanating from the handle portion and terminating in spaced-apart terminal ends. A stem is located in and supported by the handle portion being biased away from the terminal ends, the floss-type loop being sized to pass over the terminal ends and the stem to provide the floss-type material under tension between the pair of extensions.

### TECHNICAL FIELD

The present invention deals with a device for cleaning teeth and a method for its use. The invention includes floss in the form of an uninterrupted loop maintained by an implement under pressure to enable teeth to be cleaned and optionally for a new segment of floss to be advanced so that each passage of floss between teeth is fresh and not subjected to debris from previous cleaning strokes.

### BACKGROUND OF THE INVENTION

It is generally agreed upon by the dental community that plaque which remains on teeth after brushing is a major of cause of tooth and gum issues and that flossing is an effective way for removing plaque and gingivitis.

Floss can be composed of monofilaments such as depicted in FIGS. 2B and 2C as segments 24 and 25 or as a bundle of thin filaments such as illustrated as element 23 in FIG. 2A. The floss can either be uncoated (FIG. 2B) or coated with a wax 26 which could contain an antibacterial agent or sodium fluoride to increase the effectiveness of the floss and to make it easier to pass between adjacent teeth. In use, the floss is gently inserted between teeth and pressed against their insides ideally close to the gums of a user. Most dental floss is composed of either plastic (nylon, PTFE, or polyethylene) or woven fibers and, as noted above, can be flavored or unflavored, waxed or unwaxed.

Most commonly, dental floss is applied by holding a linear strand of the material between a user's fingers or by stringing the floss onto a forked-like instrument. The floss is guided between teeth and under one's gum line to remove particles of food stuck and plaque that adheres to dental surfaces.

There are various prior art suggestions for producing floss in the form of continuous loops rather than as string like linear segments. For example, U.S. Pat. No. 6,371,133 to Gant, issued on Apr. 16, 2002, discloses an endless loop in the form of an extrusion-molded thermoplastic polyurethane having a high degree of elasticity. A user will stretch the loop of flossed material causing it to thin, thus promoting its passage between adjacent teeth. U.S. Pat. No. 4,523,600 to Donovan, issued on Jun. 18, 1985, teaches the use of a loop of floss material which includes a joint where the ends of the floss have been connected to one another by knotting, causing there to be a protruding tail section, or by overlapping ends resulting in a thickened joined area which the patentee alleges assists in improving the effectiveness of the floss.

A limitation in flossing unrecognized by the prior art is the result of the application of the same segment of floss in proceeding from tooth to tooth. As floss is used between teeth, it becomes contaminated with food debris and the like which is carried along thus compromising its effectiveness. To provide an unused segment of floss as one proceeds from tooth to tooth, one would have to unwind a portion of the floss from one finger and take up the slack in a second finger when linear floss is used by hand. This is obviously cumbersome and is an operation which is rarely carried out by a user. Even when a forked appliance is employed, the segment of floss made available during the flossing operation remains static.

The present invention is intended to provide an improvement over prior art flossing by providing a convenient device for not only flossing between teeth but by presenting a fresh unused segment of floss each time a subsequent tooth is flossed.

These and further objects will be readily apparent when considering the following disclosure and appended claims.

### SUMMARY OF THE INVENTION

A device and method for its use for cleaning teeth. An uninterrupted floss-type loop is supported by an implement. The implement includes a handle portion sized to be gripped by a user and a pair of extensions emanating from the handle portion and terminating in spaced-apart terminal ends. A stem is located in and supported by the handle portion being biased away from the terminal ends, the floss-type loop being sized to pass over the terminal ends and the stem to provide the floss-type material under tension between the pair of extensions.

### BRIEF DESCRIPTION OF THE FIGURES

FIGS. 1A, 1B and 1C are plan views of floss-type loops of different dimensions for use in practicing the present invention.

FIGS. 2A, 2B and 2C are illustrations of materials useful in creating the floss-type loops of FIGS. 1A, 1B and 1C.

FIG. 3 is a partial view of a thumb wheel and biased stem useful in practicing the present invention.

FIG. 4 is a top plan view of the present invention incorporating the detailed thumb wheel arrangement shown in FIG. 3.

FIG. 5 is a side view of a scalloped floss material as a preferred embodiment useful in practicing the present invention.

### DETAILED DESCRIPTION OF THE INVENTION

Novel features which are characteristic of the invention, as to organization and method of operation, together with further objects and advantages thereof will be better understood from the following description considered in connection with the accompanying drawings, in which preferred embodiments of the invention are illustrated by way of example. It is to be expressly understood, however, that the drawings are for illustration description only and are not intended as definitions of the limits of the invention. The various features of novelty which characterize the invention are recited with particularity in the claims.

There has been broadly outlined more important features of the invention in the summary above and in order that the detailed description which follows may be better understood, and in order that the present contribution to the art may be appreciated. There are, of course, additional features of the invention that will be described hereinafter and which will form additional subject matter of the claims appended hereto. Those skilled in the art will appreciate that the conception upon which this disclosure is based readily may be utilized as a basis for the designing of other structures, methods and systems for carrying out the several purposes of the present invention. It is important therefore, that claims be regarded as including such equivalent constructions insofar as they do not depart from the spirit and scope of the present invention.

Certain terminology and the derivations thereof may be used in the following description for convenience and reference only, and will not be limiting. For example, words such as “upward,” “downward,” “left,” and “right” refer to directions in the drawings to which reference is made unless otherwise stated. Similar words such as “inward” and “outward” refer to directions toward and away from, respectively, the geometric center of a device or area and designated parts thereof. Reference in the singular tense include the plural and vice versa, unless otherwise noted.

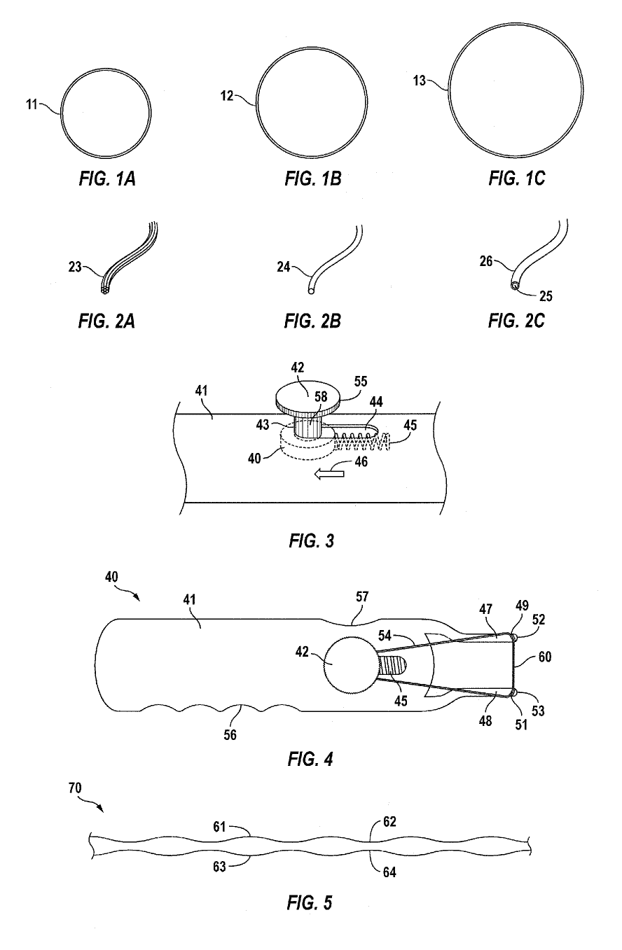

As noted previously, the present device operates with a floss-type loop which is uninterrupted as to provide a consistently uniform floss loop. As noted in FIGS. 1A, 1B and 1C, these loops can be of various sizes and employ a range of diameters, the intention being to provide an uninterrupted floss-type loop which is sized to fit between teeth of a user and be applied to and below a user's gum line to remove debris and plaque.

Uninterrupted floss-type loops 11, 12, and 13 are intended to be employed in a device in reference to FIG. 4. Device 40 includes a handle portion 41 optionally provided with thumb indent 57 and finger indents 56 to facilitate the gripping of handle 41 by a user. Uninterrupted floss-type loop 54 is installed onto device 40 as shown. It is a feature of the present device to provide uninterrupted floss-type loop 54 under tension to ensure that segment 60 intended to pass between a user's teeth is taut. As noted, uninterrupted floss-type loop 54 is triangulated between terminal ends 52 and 53 of extension pair 47 and 48 and stem 43 (FIG. 3). Uninterrupted floss-type loop 54 travels over tracks 49 and 51 which act to guide uninterrupted floss-type loop 54 as illustrated.

As noted above, it is important that uninterrupted floss-type loop 54 remain under tension. This is accomplished by biasing stem 43 away from terminal ends 52 and 53. Stem 43 can be pushed or pulled away from these terminal ends, the means to do so not being an important feature of the present invention. One illustrated way of biasing stem 43 is shown in FIG. 3. In this non-limiting example, spring 45 pushes against lower hub wheel 40 causing the assembly in the form of lower hub wheel 40, stem 43 and thumb wheel 42 to be biased in the direction of arrow 46. As uninterrupted floss-type loop 54 is intended to wrap about stem 43, its movement within open track 44 in the direction of arrow 46 causes floss-type loop 54 to be taut for the reasons stated previously. An added feature of this arrangement is that once uninterrupted floss-type loop 54 has been used, it can be easily removed from device 40 by pushing thumb wheel 42 towards extensions 47 and 48 facilitating removal of the floss from tracks 49 and 51 and shaft 43.

Another defining feature of the present invention is its ability to present an unused portion of the uninterrupted floss-type loop 54 between terminal ends 52 and 53 as segment 60 as a user proceeds to floss, from tooth pair to tooth pair. To date, there has been no convenient appliance which would facilitate the presentation of clean, unused floss as a user moves segment 60 from tooth to tooth. An appreciation of a convenient way to carry out this goal is illustrated in FIG. 3.

In turning to FIG. 3 it is noted that stem 43 is made part of an assembly which includes a means to rotate the stem, such as thumb wheel 42 although other means such as a ratcheted lever and the like could be used equally as well. If thumb wheel 42 is used as the means to rotate stem 43, it can ideally be provided with score lines 55 at its perimeter such that a user could run one's thumb or forefinger in a clockwise or counterclockwise direction over the score lines which would, in turn, cause stem 43 to rotate and move uninterrupted floss-type loop 54. The ability of the present device to do so is enhanced by the tension created on uninterrupted floss-type loop 54 by biasing stem 43 in the direction of arrow 46 as previously described. In use, one would grip handle 41 taking advantage of thumb indent 57 and finger indents 56 while moving the appliance to enable segment 60 to pass between adjacent teeth and down to or below a user's gum line. Prior to repeating this procedure on the next adjacent tooth pair, thumb wheel 42 would be rotated causing a fresh section of uninterrupted floss-type loop 54 to present itself as new segment 60 thus preventing any plaque, food particles or other contamination to be spread between teeth being flossed.

As yet a further preferred embodiment, reference is made to FIG. 5. Specifically, floss-type loop 54 can be composed of floss-like material 70 of compositions such as described previously. However, floss-like material 70 is characterized as having hills 61 and 63 and valleys 62 and 64, created by any one of well-known fabrication techniques, such as by biased embossing rollers. The scalloped profile as depicted in FIG. 5, when formed into loop 54 enhances the effectiveness of the flossing procedure as hills 61 and 63 and valleys 62 and 64 pass between adjacent teeth and over a user's gum line. As a preferred embodiment, stem 43 can be produced with scallopes or score lines 58. If scalloped, it is ideal to match the scalloping to hills 61 and 63 and valleys 62 and 64 to assist in moving floss 70 as indicated.

The above disclosure is sufficient to enable one of ordinary skill in the art to practice the invention, and provides the best mode of practicing the invention presently contemplated by the inventor. While there is provided herein a full and complete disclosure of the preferred embodiments of the invention, it is not desired to limit the invention to the exact construction, dimensions, relationships, or operations as described. Various modifications, alternative constructions, changes and equivalents will readily occur to those skilled in the art and may be employed as suitable without departing from the true spirit and scope of the invention. Such changes might involve alternative materials, components, structural arrangements, sizes, shapes, forms, functions, operational features or the like. Therefore, the above description and illustration should not be considered as limiting the scope of the invention, which is defined by the appended claims.

1. A device for cleaning teeth comprising an uninterrupted floss-type loop and an implement, said implement comprising a handle portion sized to be gripped by a user, a pair of extensions emanating from said handle portion terminating in spaced-apart terminal ends, a stem located in and supported by said handle portion, said stem being biased away from said terminal ends, said floss-type loop being sized to pass over said terminal ends and said stem to provide floss material under tension between said pair of extensions.

2. The device for cleaning teeth of claim 1 wherein said stem is rotatable such that rotation of said stem causes said floss type loop to travel over said terminal ends.

3. The device for cleaning teeth of claim 2 further comprising a thumb wheel appended to said stem.

4. The device for cleaning teeth of claim 3 wherein said thumb wheel comprises a circumference, said circumference having score lines therein.

5. The device for cleaning teeth of claim 3 wherein said stem is rotatable through rotation of said thumb wheel.

6. The device of claim 1 wherein tracks are provided at said terminal ends to act as guides for said floss-type loop.

7. The device of claim 1 wherein said floss-type loop comprises a scalloped profile of hills and valleys.

8. The device of claim 2 wherein said stem is scored to enhance movement of said floss-type loop.

9. (canceled)

10. The device of claim 8 wherein the scoring of said stem mates with the scalloped profile of said floss-type loop.

11. A method for cleaning teeth comprising the steps of providing a floss-type loop and an implement, said implement comprising a handle portion sized to be gripped by a user, a pair of extensions emanating from said handle portion terminating in spaced-apart terminal ends, a stem located in and supported by said handle portion, said stem being biased away from said terminal ends, said floss-like loop being sized to pass over said terminal ends and said stem to provide floss material under tension between said pair of extensions, gripping said handle portion and passing said floss-type loop between a user's teeth in the segment thereof residing between said pair of extensions.

12. The method of claim 11 wherein subsequent to passing said floss-type loop between a user's teeth, said stem is rotated to move said floss-type loop over said terminal ends for presenting a new portion of said floss-type material between said extensions followed by passing said new portion between said user's teeth.

13. The device for cleaning teeth of claim 1 wherein said stem is pushed away from said terminal ends.

14. The device for cleaning teeth of claim 13 wherein said stem is biased away from said terminal ends by being pushed away from said terminal ends by use of a spring.

15. The device for cleaning teeth of claim 1 wherein said stem is biased away from said terminal ends to maintain said floss-type loop taut and is pushed closer to said terminal ends against said bias to facilitate selective removal of the floss-type loop from said device.

16. The device for cleaning teeth of claim 13 wherein said handle portion further comprises an open track for passage of said stem there through, said stem being movable toward and away from said terminal ends within said open track.
